(19) United States
(12) Patent Application Publication
(10) Pub. No.: US 2022/0188951 A1
(43) Pub. Date: Jun. 16, 2022

(54) Information Processing System and Selection Support Method

(71) Applicant: Hitachi, Ltd., Tokyo (JP)

(72) Inventors: Shuntaro YUI, Tokyo (JP); Wataru TAKEUCHI, Tokyo (JP); Shinji TARUMI, Tokyo (JP)

(21) Appl. No.: 17/456,021

(22) Filed: Nov. 22, 2021

(30) Foreign Application Priority Data
Dec. 16, 2020 (JP) 2020-208038

(51) Int. Cl. G06Q 50/26; G06Q 40/08

(52) U.S. Cl. CPC G06Q 50/26; G06Q 40/08

(57) ABSTRACT

To provide an appropriate social security service considering a plurality of goals. An information processing system includes: a similar data extraction unit configured to calculate a similarity of the attribute data of the insurers and a similarity of the attribute data of the insured persons using the database; a time-series change extraction unit configured to calculate a time-series change in the clinical data of the plurality of insured persons and a time-series change in the cost data according to the plurality of social security services to be provided using the database; a learning unit configured to weight each of the clinical data and the cost data based on the calculated similarities and the calculated time-series changes, and to learn an evaluation index representing a value of the social security service; an input unit configured to receive input of an attribute of an insured person to be analyzed and a social security service; and an output unit configured to output an evaluation index of an available social security service according to an attribute of an insured person.

### CLAIM OF PRIORITY

The present application claims priority from Japanese patent application JP 2020-208038 filed on Dec. 16, 2020, the content of which is hereby incorporated by reference into this application.

### BACKGROUND OF THE INVENTION

### 1. Field of the Invention

The present invention relates to an information processing system configured to analyze healthcare data in the medical field.

### 2. Description of the Related Art

It is an urgent issue to build a sustainable medical care provision system in response to the rapid increase in medical cost due to rapid demographic changes such as the declining birthrate and aging population. In the presence of various stakeholders, evidence-based decision-making is necessary to formulate a new system that balances a guarantee of the quality of medical care and the optimization of medical cost. Utilization of accumulated data has become a global movement, and data analysis is considered as one of the effective methods for generating evidences. A high-quality medical care provision system can be established by giving incentives and penalties according to the effects and efficacy of a medical practice and measure extracted by data analysis. In efficacy analysis currently being performed, the analysis is performed according to the presence or absence of a medical practice and the providing amount.

It is an urgent issue to build a sustainable social security provision system in response to the rapid increase in medical cost due to the declining birthrate and aging population. In the presence of various stakeholders, evidence-based decision-making is necessary to formulate a new system that balances a guarantee of the quality of the social security service and the optimization of costs and to perform the social security service, and the utilization of accumulated data is required.

The following technique is the related art in the technical field. Patent Literature 1 (JP-A-2019-87239) describes a region general care business system including a database including elderly people basic data, needed care insurance data, medical insurance data, and regional measure data, in which a regional management support function unit outputs, for each business unit from medical or care data, a quantitative analysis report on elderly people information and service usage status, and a qualitative report based on an indicator showing a change in a state of a mental and physical state item; a regional information management function unit outputs an activity evaluation result related to the quantity and quality of a service in individual form for each business unit; and an elderly people information management function unit centrally manages basic information, mental and physical state usage service status, and medical status of the elderly people, and supports confirmation of an effect of a care plan and review policy examination of the next plan by referring to past histories of the basic information, mental and physical state usage service status, and medical status of the elderly people.

A system for providing a high-quality social security service can be established by implementing an effective and cost-effective service. However, when a specific service is determined, it is necessary to consider not only an effect of the service to inhibit a future disease onset, but also various numerical values such as cost required to provide the service, disease incidence, infectious disease risk, side effect risk, readmission risk, reoperation risk, and potential income by providing the service, and considering a specific aspect, the service to be provided is limited, and therefore, there is a problem that it is difficult to provide the service. In particular, which aspect should be considered may depend on an idea that a service provider and a consumer emphasize, and the lack of a unique solution makes the problem even more difficult.

### SUMMARY OF THE INVENTION

Therefore, an object of the invention is to make it possible to provide an appropriate social security service considering a plurality of goals to be achieved such as a cost, a disease onset, and an infectious disease, when a cost-effective social security service is selected. In addition, another object of the invention is to select an appropriate service even if a goal to be emphasized by the service provider and the service consumer is ambiguous, when a cost-effective social security service is selected.

A typical example of the invention disclosed in the present application is as follows. That is, an information processing system configured to support selection of a social security service, the information processing system being implemented by a computer including a calculation device configured to execute a predetermined process and a storage device connected to the calculation device, and the calculation device being accessible to a database including attribute data of a plurality of insurers, attribute data of a plurality of insured persons, supply and demand data of a plurality of social security services, clinical data of the plurality of insured persons, and cost data of a social security service provided to the insured persons, the information processing system includes: a similar data extraction unit configured to calculate a similarity of the attribute data of the insurers and a similarity of the attribute data of the insured persons using the database; a time-series change extraction unit configured to calculate a time-series change in the clinical data of the plurality of insured persons and a time-series change in the cost data according to the plurality of social security services to be provided using the database; a learning unit configured to weight each of the clinical data and the cost data based on the calculated similarities and the calculated time-series changes, and to learn an evaluation index representing a value of the social security service; an input unit configured to receive input of an attribute of an insured person to be analyzed and a social security service; and an output unit configured to output an evaluation index of an available social security service according to an attribute of an insured person.

According to one aspect of the invention, an appropriate social security service considering a plurality of goals can be provided. Problems, configurations, and effects other than those described above are made clear by the following explanation of the embodiment.

### BRIEF DESCRIPTION OF THE DRAWINGS

FIG. 1 is a configuration diagram of a social security service selection support system according to a first embodiment.

FIG. 2 is a hardware configuration diagram according to the social security service selection support system.

FIG. 3 is a flowchart showing an entire process executed by the social security service selection support system according to the first embodiment.

FIG. 4 is a diagram showing a configuration example of an insured person attribute database.

FIG. 5 is a diagram showing a configuration example of an insurer attribute database.

FIG. 6 is a diagram showing a configuration example of a disease history attribute database.

FIG. 7 is a diagram showing a configuration example of a medical service supply and demand database.

FIG. 8 is a diagram showing a configuration example of a care service supply and demand database.

FIG. 9 is a diagram showing a configuration example of a clinical information database.

FIG. 10 is a diagram showing a configuration example of a social security cost database.

FIG. 11 is a flowchart showing details of a process of step S302.

FIG. 12 is a flowchart showing details of a process of step S303.

FIG. 13 is a flowchart showing details of a process of step S304.

FIG. 14 is a diagram showing an example of a condition setting and process result display screen of the first embodiment.

FIG. 15 is a configuration diagram of a social security service selection support system according to a second embodiment.

FIG. 16 is a flowchart showing an entire process executed by the social security service selection support system according to the second embodiment.

FIG. 17 is a flowchart showing details of a process of step S307.

FIG. 18 is a diagram showing an example of a condition setting and process result display screen of the second embodiment.

### DESCRIPTION OF THE PREFERRED EMBODIMENTS

Hereinafter, embodiments of the invention will be described with reference to the drawings.

### First Embodiment

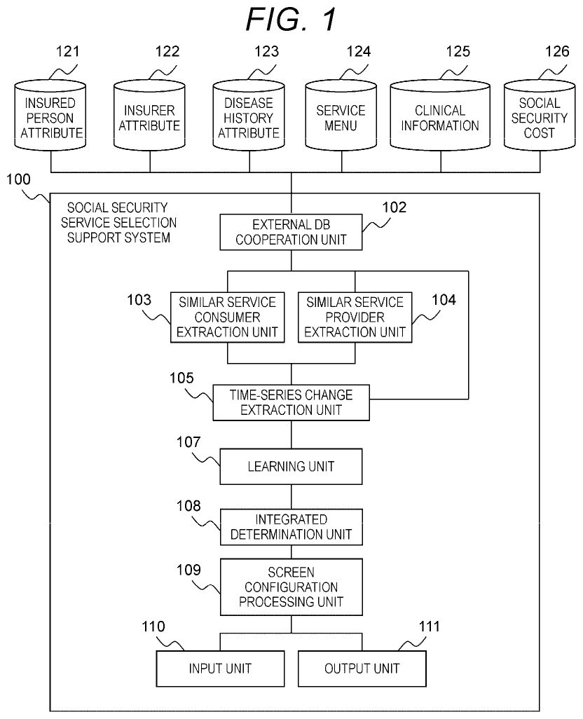

FIG. 1 is a configuration diagram of a social security service selection support system 100 according to the first embodiment.

The social security service selection support system 100 according to this embodiment includes an external DB cooperation unit 102, a similar service consumer extraction unit 103, a similar service provider extraction unit 104, a time-series change extraction unit 105, a learning unit 107, an integrated determination unit 108, a screen configuration processing unit 109, an input unit 110, and an output unit 111. The external DB cooperation unit 102 has a function of cooperating with a database provided outside this system, for example, acquiring data stored in an insured person attribute database 121, an insurer attribute database 122, a disease history attribute database 123, a service menu database 124, a clinical information database 125, and a social security cost database 126. The external DB cooperation unit 102 may cooperate with a database other than those illustrated, and read and write data from and to the database.

The input unit 110 is an interface that receives input from a user. The output unit 111 is an interface that outputs an execution result of a program in a user-visible form.

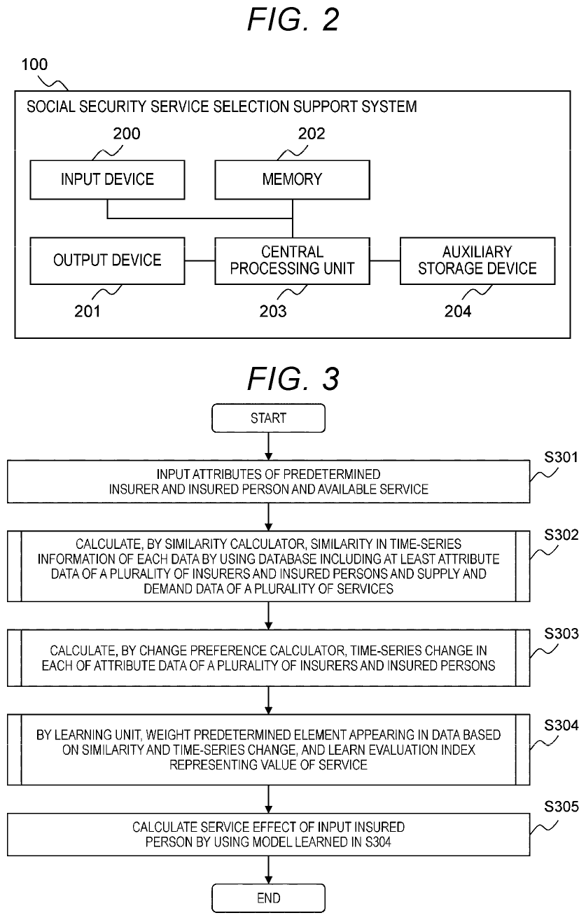

FIG. 2 is a hardware configuration diagram of the social security service selection support system 100 according to this embodiment.

An input device 200 is a keyboard, a mouse, a pen tablet, and the like that constitutes the input unit 110, and is an interface that receives input from the user. An output device 201 is a display device such as a liquid crystal display device or a cathode-ray tube (CRT) that constitutes the output unit 111, and is an interface that outputs an execution result of a program in a user-visible form. The output device 201 may be a device that outputs to a paper medium such as a printer. A terminal connected to the social security service selection support system 100 via a network may provide the input device 200 and the output device 201.

A central processing unit 203 is a processor (calculation device) that executes a program. Specifically, the external DB cooperation unit 102, the similar service consumer extraction unit 103, the similar service provider extraction unit 104, the time-series change extraction unit 105, the learning unit 107, the integrated determination unit 108, and the screen configuration processing unit 109 are implemented by executing the program by the processor. A part of the process performed by executing the program by the processor may be executed by other types (for example, by hardware) of calculation devices (for example, field programmable gate array (FPGA) or application specific integrated circuit (ASIC)).

A memory 202 includes a ROM which is a non-volatile storage element and a RAM which is a volatile storage element. The ROM stores an invariable program (for example, a BIOS) or the like. The RAM is a high-speed and volatile storage element such as dynamic random access memory (DRAM), and temporarily stores a program executed by the central processing unit 203 and data to be used to execute the program.

An auxiliary storage device 204 is a non-volatile storage device with large-capacity such as a magnetic storage device (HDD) and a flash memory (SSD). The auxiliary storage device 204 stores the data to be used to execute the program by the central processing unit 203 and the program executed by the central processing unit 203. Specifically, the auxiliary storage device 204 may store all or a part of the databases 121 to 126 described above. A part or all of each database 121 to 126 is stored in the memory 202 for a short period of time as the program is executed. In addition, the program is read from the auxiliary storage device 204, loaded to the memory 202, and executed by the central processing unit 203.

The social security service selection support system 100 (not shown) includes a communication interface that controls communication with other devices according to a predetermined protocol.

The program executed by the central processing unit 203 is introduced into the social security service selection support system 100 via a removable media (CD-ROM, flash memory, etc.) or a network, and stored in the non-volatile auxiliary storage device 204, which is a non-transitory storage medium. Therefore, the social security service selection support system 100 may include an interface that reads data from the removable media.

The social security service selection support system 100 is a computer system which includes one physical computer or a plurality of computers configured in a logical or physical manner, and may operate on a virtual computer constructed on a plurality of physical computer resources.

FIG. 3 is a flowchart showing an entire process executed by the social security service selection support system 100 according to this embodiment.

Firstly, the external DB cooperation unit 102 reads an attribute of a predetermined insured person from the insured person attribute database 121, reads an attribute of a predetermined insurer from the insurer attribute database 122, and reads information about an available service from the service menu database 124 (S301).

Next, the similar service provider extraction unit 104 uses a similarity calculator to calculate a similarity of insurers in time-series information of at least attribute data of a plurality of insurers and supply and demand data of a plurality of services. In addition, the similar service consumer extraction unit 103 uses the similarity calculator to calculate a similarity of insured persons in time-series information of at least attribute data of a plurality of insured persons and supply and demand data of a plurality of services (S302).

Then, the time-series change extraction unit 105 uses a change preference calculator to calculate a time-series change in each of the attribute data of the plurality of insurers and insured persons (S303).

Then, the learning unit 107 weights a predetermined element appearing in these data based on the calculated similarity and the calculated time-series change (change preference), and learns an evaluation index representing a value of a service (S304).

Finally, the integrated determination unit 108 calculates a service effect of the input insured person by using a model learned in S304 (S305).

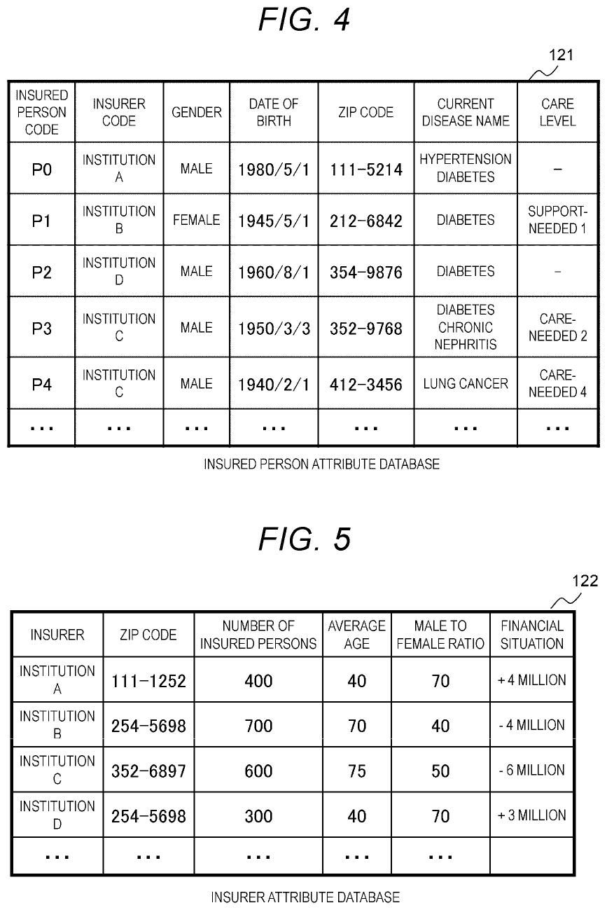

Next, data structures of databases of this embodiment will be described with reference to FIG. 4 to FIG. 10. Although each database is described in a table format in FIGS. 4 to 10, these databases may include data structures other than tables (for example, lists, queues, and the like).

FIG. 4 is a diagram showing a configuration example of the insured person attribute database 121.

The insured person attribute database 121 stores data indicating attributes of an insured person, and includes data about an insured person code, an insurer code, a gender, a date of birth, a zip code, a current disease name, and a care level. The insured person code is identification information uniquely given to the insured person, and is used in common with other databases. The insurer code is identification information uniquely given to the insurer (health insurance association, local government), and is used in common with other databases. The gender is a gender of the insured person. The date of birth is a date of birth of the insured person. The zip code is a zip code of an address of the insured person, and represents a rough location of the insured person. The address (prefecture or municipality or the like) may be stored instead of the zip code. Since disease incidence and frequently used services (treatment methods or the like) are regional, information indicating a rough address such as a zip code is used to calculate a similarity of insured persons. The current disease name is a name of an injury or disease that the insured person is suffering from. The care level is a level of care for which the insured person is certified. Data used to extract similar insured persons are stored in the insured person attribute database 121, and data of other items may be stored in the insured person attribute database 121 and used to extract the similar insured persons.

FIG. 5 is a diagram showing a configuration example of the insurer attribute database 122.

The insurer attribute database 122 stores data indicating attributes of an insurer, and includes data about an insurer name, a zip code, the number of insured persons, an average age, a male to female ratio, and a financial situation. The insurer name is a name of the insurer (for example, a health insurance association). The zip code is a zip code of an address of the insurer, and represents a rough location of the insurer. The address (prefecture or municipality or the like) may be stored instead of the zip code. Since disease incidence and frequently used services (treatment methods or the like) are regional, information indicating a rough address such as a zip code is used to calculate a similarity of insurers. The number of insured persons is the number of insured persons belonging to the insurer and represents a scale of the insurer. A numerical value indicating the scale of the insurer such as an amount of expenses may be stored instead of the number of insured persons. The average age is an average value of ages of the insured persons belonging to the insurer. The male to female ratio is a ratio of male to female of the insured persons belonging to the insurer. The financial situation is an annual balance of the insurer. Data used to extract similar insurers are stored in the insurer attribute database 122, and data of other items may be stored in the insurer attribute database 121 and used to extract the similar insurers.

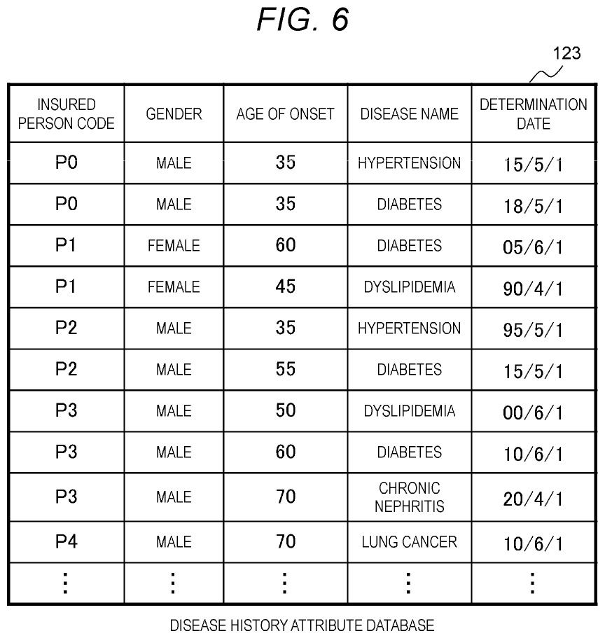

FIG. 6 is a diagram showing a configuration example of the disease history attribute database 123.

The disease history attribute database 123 stores data about an injury or disease that the insured person has been suffered from, and includes data about an insured person code, a gender, an age of onset, a disease name, and a determination date. The insured person code is identification information uniquely given to the insured person, and is used in common with other databases. The gender is a gender of the insured person. The age of onset is an age at which an injury or disease described in a disease name field developed. The disease name is a name of an injury or disease that the insured person is currently suffering from. The determination date is a date on which an injury or disease is determined to be the injury or disease described in the disease name field.

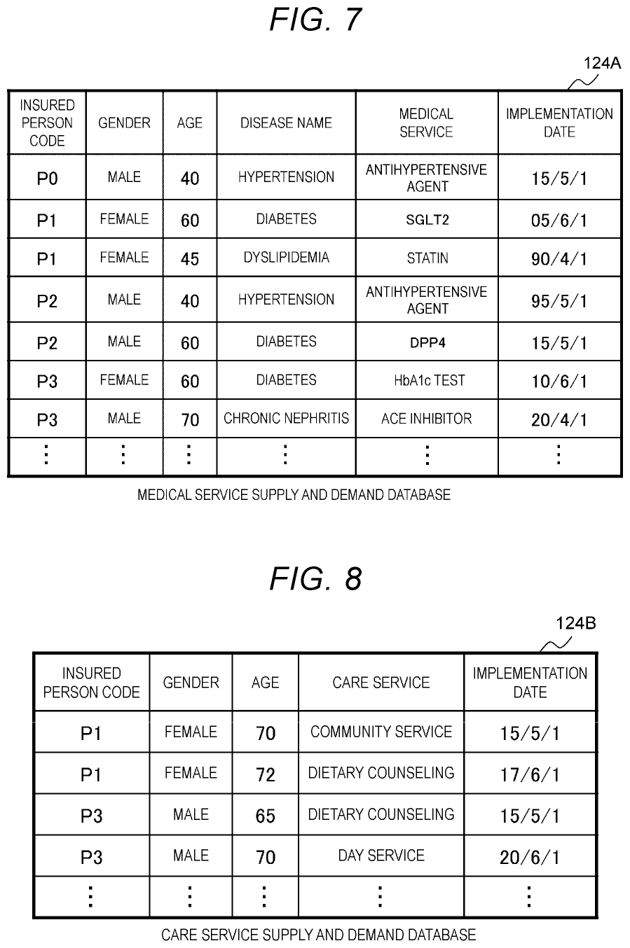

FIG. 7 is a diagram showing a configuration example of a medical service supply and demand database 124A, and FIG. is a diagram showing a configuration example of a care service supply and demand database 124B. This medical service supply and demand database 124A and the care service supply and demand database 124B shown in FIG. 8 constitute the service menu database 124.

The medical service supply and demand database 124A shown in FIG. 7 stores data about a medical service provided to the insured person, and includes data about an insured person code, a gender, an age, a disease name, a medical service, and an implementation date. The insured person code is identification information uniquely given to the insured person, and is used in common with other databases. The gender is a gender of the insured person. The age is an age of the insured person. The disease name is a name of an injury or disease that the insured person is suffering from. The medical service is a name of a medical service that the insured person receives. The medical service recorded in the medical service supply and demand database 124A includes a medical examination, a surgery, an examination, dosage, rehabilitation, and the like. The implementation date is a date on which the medical service was provided to the insured person.

The care service supply and demand database 124B shown in FIG. 8 stores data about a care service provided to the insured person, and includes data about an insured person code, a gender, an age, a care service, and an implementation date. The insured person code is identification information uniquely given to the insured person, and is used in common with other databases. The gender is a gender of the insured person. The age is an age of the insured person. The care service is a name of a care service provided to the insured person. The implementation date is a date on which the care service was provided to the insured person.

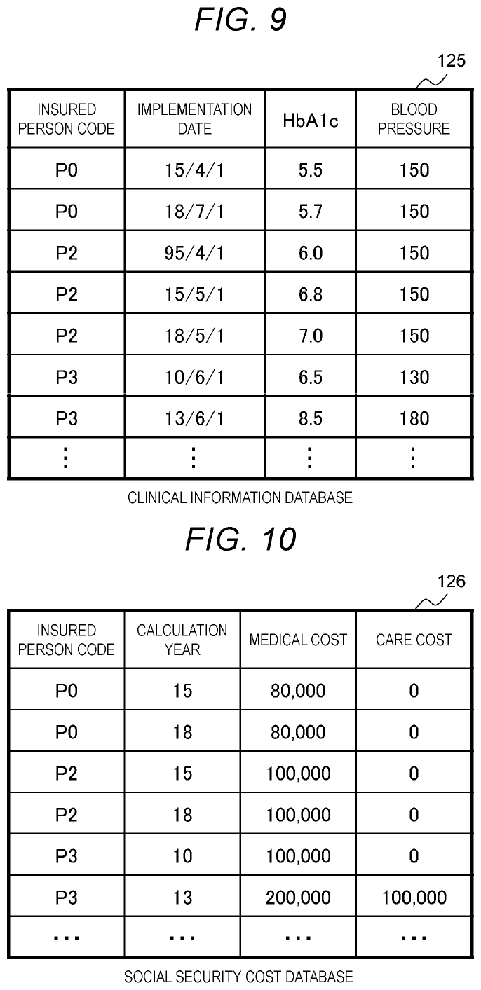

FIG. 9 is a diagram showing a configuration example of the clinical information database 125.

The clinical information database 125 stores a result of a medical examination and a result of an examination received by the insured person, and includes data about an insured person code, an implementation date, HbA1c, and a blood pressure. The insured person code is identification information uniquely given to the insured person, and is used in common with other databases. The implementation date is a date on which the insured person received the examination. The HbA1c and the blood pressure are results of the examination received by the insured person, and items other than the HbA1c and the blood pressure may be recorded.

FIG. 10 is a diagram showing a configuration example of the social security cost database 126.

The social security cost database 126 stores a social security cost required for the medical service and the care service provided to the insured person, and includes data about an insured person code, a calculation year, a medical cost, and a care cost. The insured person code is identification information uniquely given to the insured person, and is used in common with other databases. The calculation year is a year in which the medical cost or the care cost was calculated. The medical cost is a medical cost paid for the insured person, and the care cost is a care cost paid for the insured person.

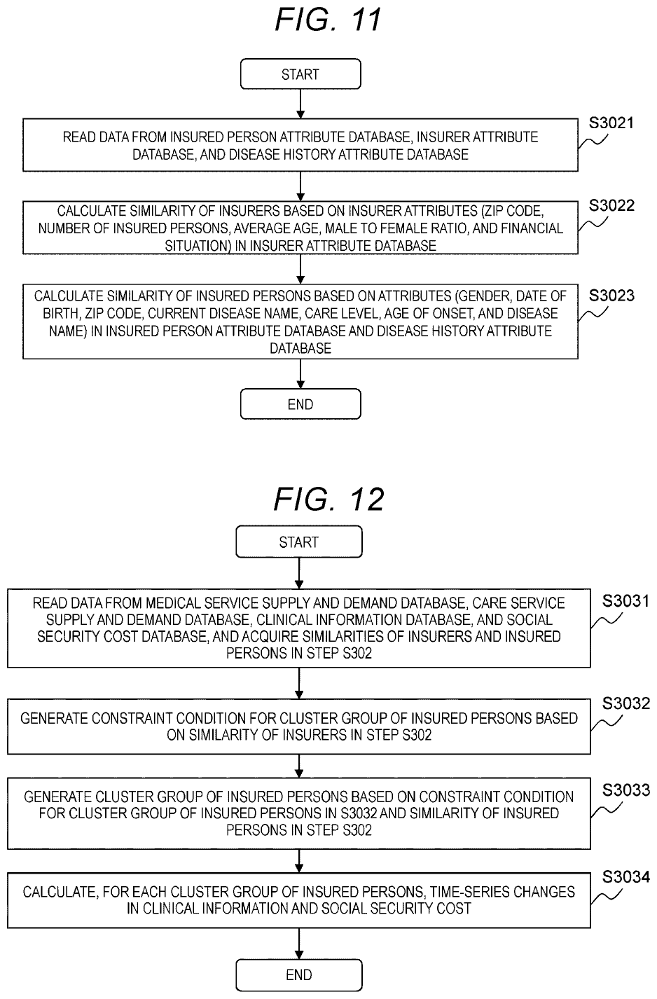

FIG. 11 is a flowchart showing details of the process of step S302 shown in FIG. 3.

Firstly, the similar service consumer extraction unit 103 reads necessary data from the insured person attribute database 122 and the disease history attribute database 123. In addition, the similar service provider extraction unit 104 reads necessary data from the insurer attribute database 121 (S3021).

Next, the similar service provider extraction unit 104 uses the similarity calculator to calculate the similarity of the insurers based on the insurer attributes (for example, the zip code, the number of insured persons, the average age, the male to female ratio, the financial situation, and the like) in the insurer attribute database 121 (S3022).

Then, the similar service consumer extraction unit 103 uses the similarity calculator to calculate a change in a value in a time series and calculate the similarity of the insured persons, based on the insured person attributes in the insured person attribute database 122 and injury or disease data in the disease history attribute database 123 (for example, the gender, the date of birth, the zip code, the current disease name, the care level, the age of onset, the disease name, and the like) (S3023).

FIG. 12 is a flowchart showing details of the process of step S303 shown in FIG. 3. In step S303, a data item with a large change in clinical information or in a social security cost is extracted.

Firstly, the time-series change extraction unit 105 reads necessary data from the medical service supply and demand database 124A, the care service supply and demand database 124B, the clinical information database 125, and the social security cost database 126, and acquires the similarity of the insurers and the similarity of the insured persons calculated in step S302 (S3031).

Next, the time-series change extraction unit 105 uses the change preference calculator to generate a constraint condition for a cluster group of the insured persons based on the similarity of the insurers calculated in step S302 (S3032). Since a service provided to an insurer has a tendency depending on the attribute (for example, the region) of the insured person, when the generation of the cluster group of the insured persons is limited by the similarity of the insurers, an appropriate cluster group of the insured persons can be generated.

Then, the time-series change extraction unit 105 uses the change preference calculator to generate a constraint condition for an insured person cluster group based on the constraint condition for the cluster group of the insured persons generated in S3032 and the similarity of the insured persons calculated in step S302, and generate a cluster group of the insured persons according to the generated constraint condition (S3033).

Thereafter, the time-series change extraction unit 105 uses the data read from the medical service supply and demand database 124A, the care service supply and demand database 124B, the clinical information database 125, and the social security cost database 126 to calculate, for each generated cluster group of the insured persons, time-series changes in the clinical information and the social security cost during each service providing period regarding each item of the medical service and the care service (S3034).

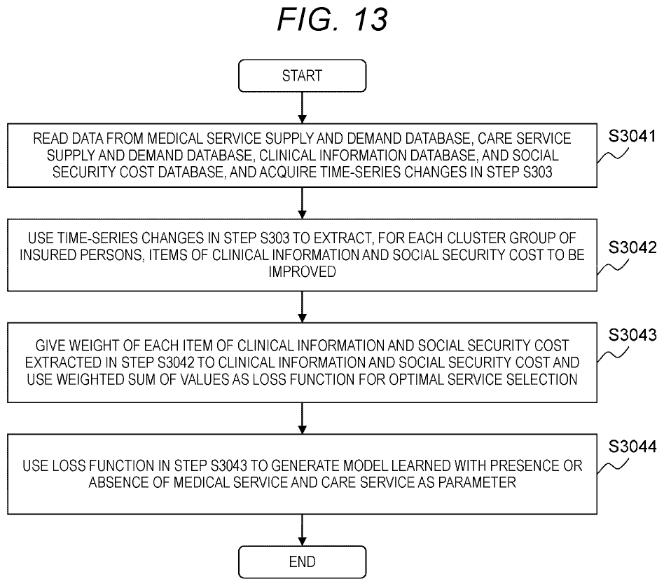

FIG. 13 is a flowchart showing details of the process of step S304 shown in FIG. 3.

Firstly, the learning unit 107 reads necessary data from the medical service supply and demand database 124A, the care service supply and demand database 124B, the clinical information database 125, and the social security cost database 126, and acquires the time-series changes in the clinical information and the social security cost calculated in step S303 (S3041).

Next, the learning unit 107 uses the time-series changes calculated in step S303 to extract, for each of the cluster groups of the insured persons, items of the clinical information and the social security cost whose numerical values are improved (S3042). The improvement of the numerical values in step S3042 means that the numerical values do not necessarily have to be improved and have not deteriorated significantly, and the numerical values can be controlled.

Then, the learning unit 107 weights each item of the clinical information and the social security cost extracted in step S3042, and uses a weighted sum of values as a loss function. This loss function is used to select an appropriate service (S3043). For example, it is advisable to give a weight having a large value to an item whose numerical value is improved, and to give a weight having a small value to an item whose numerical value is not improved.

Next, the learning unit 107 uses the loss function calculated in step S3043 to generate a model learned with the presence or absence of each item of the medical service and the care service as a parameter (S3044).

Thus, in step S304, it is possible to learn the evaluation index representing a value of each service by weighting the predetermined element appearing in the data for each of the cluster groups of the insured persons based on the similarity and the change preference. For example, when a weight of a blood pressure value is increased in a specific cluster, an antihypertensive agent tends to be administered earlier by administering a therapeutic drug for diabetes, and a weight of a blood pressure control is increased.

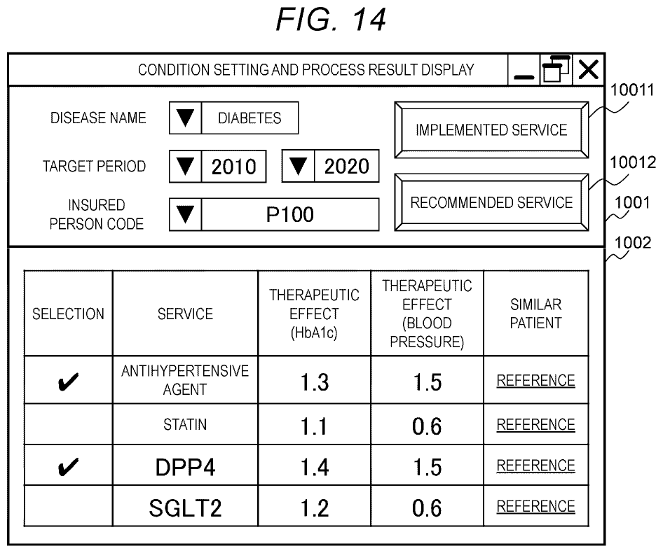

FIG. 14 is a diagram showing an example of a condition setting and process result display screen displayed by the output unit 111.

The condition setting and process result display screen includes a condition setting region 1001 and a processing result presentation region 1002. An implemented service button 10011 for extracting a service provided to an insured person for whom a condition is set, a recommended service button 10012 for extracting a service which should be provided to the insured person for whom a condition is set, and an option input field by pull-down for setting an analysis condition are displayed in the condition setting region 1001. The option input field includes, for example, a disease name input unit, a target period input unit, and an insured person code input unit. An appropriate service can be selected for each of the cluster groups of the insured persons by the insured person code input unit. In an illustrated example, conditions for extracting services (medical services, care services, and the like) provided to a diabetic patient are set by using data from 2010 to 2020.

The processing result presentation region 1002 shows a state after the implemented service button 10011 is operated, and displays a service provided and effective to the insured person for whom a condition is set. In addition, when the recommended service button 10012 is operated, a service recommended to be provided to the insured person for whom a condition is set is displayed. A similar patient reference button is a button operated to display an attribute of similar patients to which each service is provided. A selection field of the processing result presentation region 1002 is operated to register a service finally determined by the user.

The social security service selection support system 100 according to the first embodiment makes it possible to provide an appropriate social security service considering a plurality of goals to be achieved such as cost and a disease onset, when a cost-effective social security service is selected. In addition, the social security service selection support system 100 according to the first embodiment makes it possible to select an appropriate service even if a goal to be emphasized by the service provider and the service consumer is ambiguous, when a cost-effective social security service is selected.

### Second Embodiment

Next, the second embodiment of the invention will be described. In the second embodiment, differences from the first embodiment will be mainly described, the same functions and configurations as those in the first embodiment will be denoted by the same reference numerals, and the description thereof will be omitted.

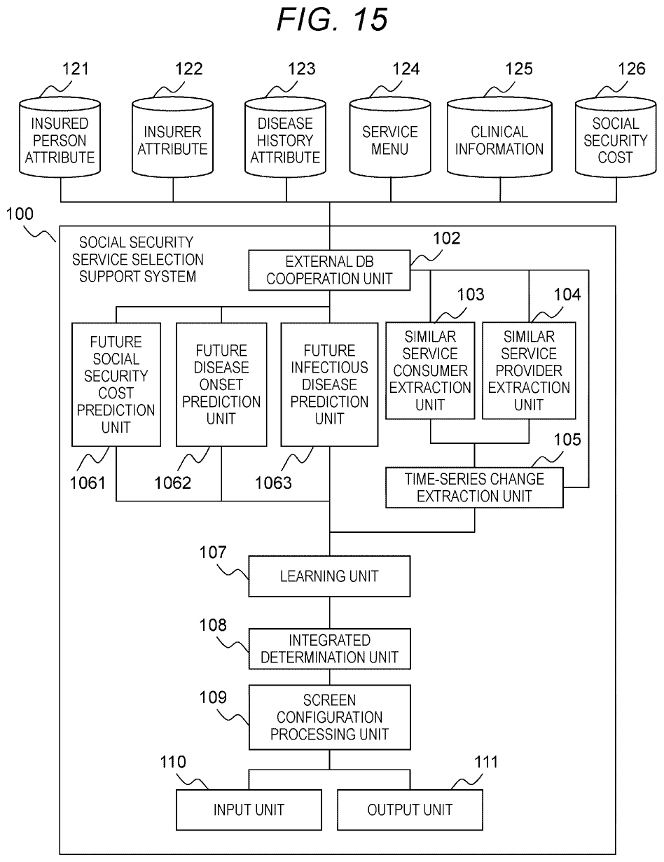

FIG. 15 is a configuration diagram of a social security service selection support system 100 according to the second embodiment.

The social security service selection support system 100 according to this embodiment includes the external DB cooperation unit 102, the similar service consumer extraction unit 103, the similar service provider extraction unit 104, the time-series change extraction unit 105, a future social security cost prediction unit 1061, a future disease onset prediction unit 1062, a future infectious disease prediction unit 1063, the learning unit 107, the integrated determination unit 108, the screen configuration processing unit 109, the input unit 110, and the output unit 111.

The future social security cost prediction unit 1061 predicts a future social security cost. The future disease onset prediction unit 1062 predicts a future disease onset. Even if data is stored in a database for a short period of time, the learning unit 107 can learn, by the future social security cost prediction unit 1061 and the future disease onset prediction unit 1062, data in a period of time when the data is not stored in the database. The future infectious disease prediction unit 1063 predicts an onset of a future infectious disease. In order to predict this onset of the infectious disease, a database, in which an activity (action history, telework rate, frequency of going out, activity range, and the like), a region, a diagnosis result, a medical history, and the like are accumulated, is prepared. By the future infectious disease prediction unit 1063, an occurrence of the future infectious disease can be predicted, and clinical information and social security cost associated with the future infectious disease can be predicted. At least one of the future disease onset prediction unit 1062 and the future infectious disease prediction unit 1063 may be implemented, or both of them may be implemented.

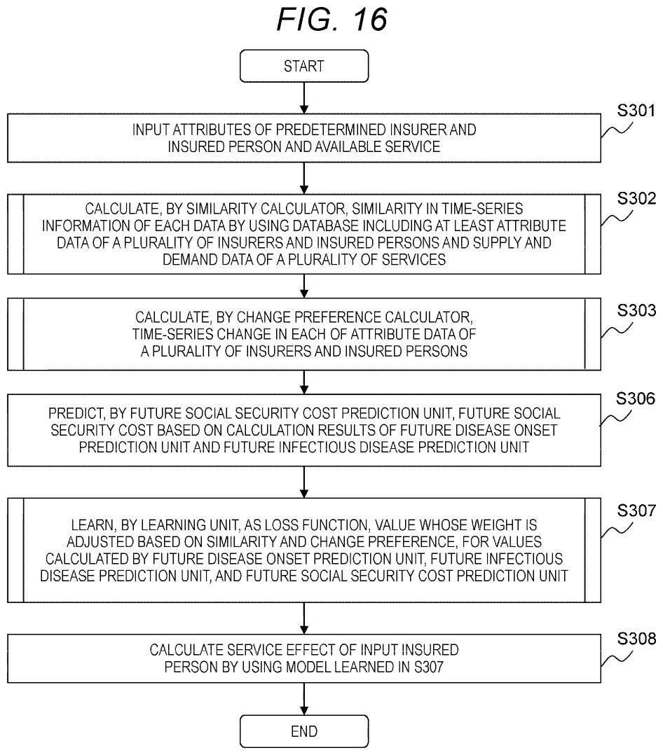

FIG. 16 is a flowchart showing an entire process executed by the social security service selection support system 100 according to this embodiment.

Firstly, the external DB cooperation unit 102 reads an attribute of a predetermined insured person from the insured person attribute database 121, reads an attribute of a predetermined insurer from the insurer attribute database 122, and reads information about an available service from the service menu database 124 (S301).

Next, the similar service provider extraction unit 104 uses a similarity calculator to calculate a similarity of insurers in time-series information of at least attribute data of a plurality of insurers and supply and demand data of a plurality of services. In addition, the similar service consumer extraction unit 103 uses the similarity calculator to calculate a similarity of insured persons in time-series information of at least attribute data of a plurality of insured persons and supply and demand data of a plurality of services (S302).

Then, the time-series change extraction unit 105 uses a change preference calculator to calculate a time-series change in each of the attribute data of the plurality of insurers and insured persons (S303).

Then, the future social security cost prediction unit 1061 uses the future disease onset prediction unit 1062 and the future infectious disease prediction unit 1063 to predict a future social security cost (S306).

Then, regarding values calculated by the future disease onset prediction unit 1062, the future infectious disease prediction unit 1063, and the future social security cost prediction unit 1061, the learning unit 107 learns a loss function, which is obtained by weighting a predetermined element appearing in these data based on the calculated similarity and the calculated time-series change (change preference), as an evaluation index representing a value of the service (S307).

Next, the integrated determination unit 108 calculates a service effect of the input insured person by using a model learned in S307 (S308).

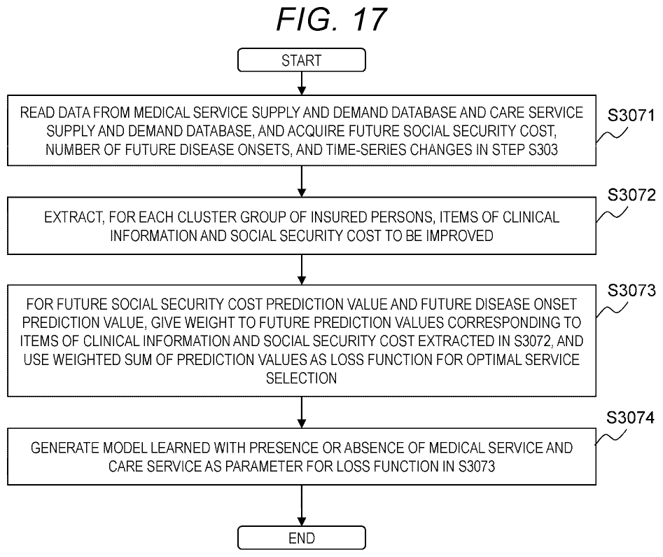

FIG. 17 is a flowchart showing details of the process of step S307 shown in FIG. 16.

Firstly, the learning unit 107 reads necessary data from the medical service supply and demand database 124A and the care service supply and demand database 124B, and acquires the future social security cost predicted in step 306, the number of future disease onsets, and the time-series changes in the clinical information and the social security cost calculated in step S303 (S3071).

Next, the learning unit 107 uses the time-series changes calculated in step S303 to extract, for each of the cluster groups of the insured persons, items of the clinical information and the social security cost whose numerical values are to be improved (S3072). The improvement of the numerical values in step S3072 means that the numerical values do not necessarily have to be improved and have not deteriorated significantly, and the numerical values can be controlled, which is similar to the meaning as in step S3042.

Then, the learning unit 107 weights each item of the clinical information and the social security cost extracted in step S3072, and uses a weighted sum of values as a loss function. This loss function is used to select an appropriate service (S3073). For example, it is advisable to give a weight having a large value to an item whose numerical value is improved, and to give a weight having a small value to an item whose numerical value is not improved.

Finally, the learning unit 107 uses the loss function calculated in step S3073 to generate a model learned with the presence or absence of each item of the medical service and the care service as a parameter (S3074).

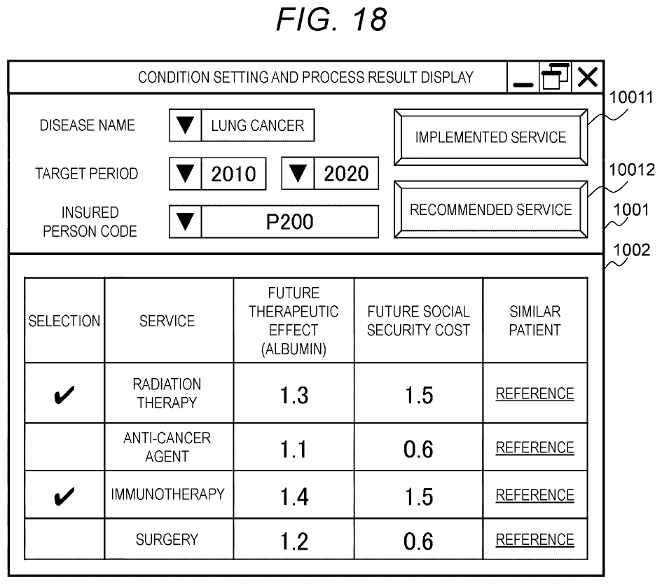

FIG. 18 is a diagram showing an example of a condition setting and process result display screen displayed by the output unit 111 in the second embodiment.

The condition setting and process result display screen includes a condition setting region 1001 and a processing result presentation region 1002. An implemented service button 10011 for extracting a service provided to an insured person for whom a condition is set, a recommended service button 10012 for extracting a service which should be provided to the insured person for whom a condition is set, and an option input field by pull-down for setting an analysis condition are displayed in the condition setting region 1001. In an illustrated example, conditions for extracting services (medical services, care services, and the like) provided to a lung cancer patient are set by using data from 2010 to 2020.

The processing result presentation region 1002 on the condition setting and process result display screen shown in FIG. 18 shows a state after the recommended service button 10012 is operated, and displays a service provided and effective in the future to the insured person for whom a condition is set. In addition, when the implemented service button 10011 is operated, a service provided and effective to the insured person for whom a condition is set is displayed. A similar patient reference button is a button operated to display an attribute of similar patients to which each service is provided.

As described above, the social security service selection support system 100 according to the embodiments of the invention supports selection of a social security service, and includes the similar data extraction unit (similar service consumer extraction unit 103, similar service provider extraction unit 104) configured to use a database to calculate a similarity of attribute data of the insurers and a similarity of attribute data of the insured persons, the time-series change extraction unit 105 configured to use the database to calculate a time-series change in clinical data of a plurality of insured persons and a time-series change in cost data according to a plurality of social security services to be provided, the learning unit 107 configured to weight each of the clinical data and the cost data based on the calculated similarities and the calculated time-series changes, and learn an evaluation index representing a value of a social security service, the input unit 110 configured to receive input of an attribute of an insured person to be analyzed and a social security service, and the output unit 111 configured to output an evaluation index of an available social security service according to the attributes of the insured persons. Therefore, the social security service selection support system 100 can provide an appropriate social security service considering a plurality of goals to be achieved such as a cost, a disease onset, and an infectious disease. In addition, an appropriate social security service can be selected even if a goal to be emphasized by the service provider and the service consumer is ambiguous.

Further, the time-series change extraction unit 105 generates a constraint condition for a cluster group of the insured persons based on the similarity of the attribute data of the insurers, generates the cluster group of the insured persons based on the generated constraint condition and the similarity of the attribute data of the insured persons, and calculate, for each generated cluster group, the time-series change in the clinical data of the plurality of insured persons and the time-series change in the cost data. Therefore, since a service provided to an insurer has a tendency depending on the attribute of the insured person, an appropriate cluster group of the insured persons can be generated by limiting the generation of the cluster group of the insured persons by the similarity of the insurers.

Furthermore, the learning unit 107 extracts, for each of the cluster groups of the insured persons, clinical data and cost data in which the calculated time-series changes satisfy a predetermined condition (for example, the numerical values have not deteriorated significantly, and can be controlled), and weights the extracted clinical data and cost data to generate, as an evaluation index, a loss function based on a weighted sum of item values. Therefore, the evaluation index representing a value of each service can be learned.

Furthermore, the social security service selection support system 100 further includes a prediction unit (future disease onset prediction unit 1062, future infectious disease prediction unit 1063) configured to predict a risk value including at least one of onsets of future diseases and infectious diseases, and a service cost prediction unit (future social security cost prediction unit 1061) configured to use the risk value to predict future cost data of the social security services, and the learning unit 107 weights each of the clinical data and the cost data based on the risk value and the future cost data to learn the evaluation index representing the value of the social security service. Therefore, even if data is stored in a database for a short period of time, the learning unit 107 can learn, based on the predicted values, data for a period of time when the data is not stored in the database.

Furthermore, the learning unit 107 extracts, for each of the cluster groups of the insured persons, the clinical data and the cost data in which the calculated time-series changes satisfy a predetermined condition, and weights the extracted clinical data and cost data to generate, as an evaluation index, a loss function based on a weighted sum of item values, based on the predicted risk value and the predicted future cost data. Therefore, the evaluation index representing a value of each service can be learned.

It should be noted that the invention is not limited to the above-mentioned embodiments, and includes various modifications and the equivalent configurations within the gist of the scope of the appended claims. For example, the above-mentioned embodiments are described in detail for a better understanding of the invention, and the invention is not necessarily limited to those including all the configurations described above. Further, a part of the configurations according to a given embodiment may be replaced by the configurations according to another embodiment. Further, the configurations according to another embodiment may be added to the configurations according to a given embodiment. Furthermore, a part of the configurations according to each embodiment may be added to, deleted from, or replaced by another configuration.

In addition, the above-mentioned configurations, functions, processing units, processing measures and the like may be realized partly or entirely by hardware, for example, by designing an integrated circuit, and may be realized partly or entirely by software by causing a processor to interpret and execute programs that implement those functions.

The information of programs, tables, and files, and the like to implement the functions may be stored in a storage device such as a memory, a hard disk drive, or a solid state drive (SSD), or a storage medium such as an IC card, or an SD card, and a DVD.

Further, control lines and information lines that are assumed to be necessary for the sake of description are described, but not all the control lines and information lines that are necessary in terms of implementation are described. It can be considered that almost all components are actually interconnected.

What is claimed is:

1. An information processing system configured to support selection of a social security service,
the information processing system being implemented by a computer including a calculation device configured to execute a predetermined process and a storage device connected to the calculation device,
the calculation device being accessible to a database including attribute data of a plurality of insurers, attribute data of a plurality of insured persons, supply and demand data of a plurality of social security services, clinical data of the plurality of insured persons, and cost data of a social security service provided to the insured persons,
the information processing system comprising:
an input unit configured to receive input of an attribute of an insured person to be analyzed and a social security service;
a similar data extraction unit configured to calculate a similarity of the attribute data of the insurers and a similarity of the attribute data of the insured persons using the database;
a time-series change extraction unit configured to calculate a time-series change in the clinical data of the plurality of insured persons and a time-series change in the cost data according to the plurality of social security services to be provided using the database;
a learning unit configured to weight each of the clinical data and the cost data based on the calculated similarities and the calculated time-series changes, and to learn an evaluation index representing a value of the social security service; and
an output unit configured to output an evaluation index of an available social security service according to an attribute of an insured person.

2. The information processing system according to claim 1, wherein
the time-series change extraction unit is configured to:
generate a constraint condition for a cluster group of insured persons based on the similarity of the attribute data of the insurers,
generate a cluster group of insured persons based on the generated constraint condition and the similarity of the attribute data of the insured persons, and
calculate, for each generated cluster group, a time-series change in the clinical data of the plurality of insured persons and a time-series change in the cost data

3. The information processing system according to claim 2, wherein
the learning unit is configured to:
extract, for each cluster group of insured persons, clinical data and cost data in which the calculated time-series changes satisfy a predetermined condition, and
weight the extracted clinical data and cost data to generate, as the evaluation index, a loss function based on a weighted sum of item values.

4. The information processing system according to claim 2, further comprising:
a prediction unit configured to predict a risk value including at least one of future disease onsets; and
a service cost prediction unit configured to predict future cost data of the social security service using the risk value, wherein
the learning unit weights each of the clinical data and the cost data based on the predicted risk value and the predicted future cost data, and to learn an evaluation index representing a value of the social security service.

5. The information processing system according to claim 4, wherein
the learning unit is configured to:
extract, for each cluster group of insured persons, clinical data and cost data in which the calculated time-series changes satisfy a predetermined condition, and
weight the extracted clinical data and cost data based on the predicted risk value and the predicted future cost data to generate, as the evaluation index, a loss function based on a weighted sum of item values.

6. A selection support method of supporting selection of a social security service by a computer,
the computer including a calculation device configured to execute a predetermined process and a storage device connected to the calculation device,
the calculation device being accessible to a database including attribute data of a plurality of insurers, attribute data of a plurality of insured persons, supply and demand data of a plurality of social security services, clinical data of the plurality of insured persons, and cost data of a social security service provided to the insured persons,
the selection support method comprising:
an input step of receiving, by the calculation device, input of an attribute of an insured person to be analyzed and a social security service;
a similar data extraction step of calculating, by the calculation device, a similarity of the attribute data of the insurers and a similarity of the attribute data of the insured persons using the database;
a time-series change extraction step of calculating, by the calculation device, a time-series change in the clinical data of the plurality of insured persons and a time-series change in the cost data according to the plurality of social security services to be provided using the database;
a learning step of weighting, by the calculation device, each of the clinical data and the cost data based on the calculated similarities and the calculated time-series changes, and learning an evaluation index representing a value of the social security service; and
an output step of outputting, by the calculation device, an evaluation index of an available social security service according to an attribute of an insured person.

7. The selection support method according to claim 6, wherein
in the time-series change extraction step, the calculation device is configured to:
generate a constraint condition for a cluster group of insured persons based on the similarity of the attribute data of the insurers,
generate a cluster group of insured persons based on the generated constraint condition and the similarity of the attribute data of the insured persons, and
calculate, for each generated cluster group, a time-series change in the clinical data of the plurality of insured persons and a time-series change in the cost data.

8. The selection support method according to claim 7, wherein
in the learning step, the calculation device is configured to:
extract, for each cluster group of insured persons, clinical data and cost data in which the calculated time-series changes satisfy a predetermined condition, and
weight the extracted clinical data and cost data to generate, as the evaluation index, a loss function based on a weighted sum of item values.

9. The selection support method according to claim 7, further comprising:
a prediction step of predicting, by the calculation device, a risk value including at least one of future disease onsets; and
a service cost prediction step of predicting, by the calculation device, future cost data of the social security service using the risk value, wherein
in the learning step, the calculation device is configured to weight each of the clinical data and the cost data based on the predicted risk value and the predicted future cost data, and to learn an evaluation index representing a value of the social security service.

10. The selection support method according to claim 9, wherein
in the learning step, the calculation device is configured to:
extract, for each cluster group of insured persons, clinical data and cost data in which the calculated time-series changes satisfy a predetermined condition, and
weight the extracted clinical data and cost data based on the predicted risk value and the predicted future cost data to generate, as the evaluation index, a loss function based on a weighted sum of item values.
